(19) United States
(12) Patent Application Publication
(10) Pub. No.: US 2024/0272301 A1
(43) Pub. Date: Aug. 15, 2024

(54) Trailer Detection for Autonomous Vehicles

(71) Applicant: Venti Technologies, Singapore (SG)

(72) Inventors: Sun XIN, Singapore (SG); Mahdi ABOLFAZLI ESFAHANI, Singapore (SG); Xinxin DU, Singapore (SG)

(21) Appl. No.: 18/437,587

(22) Filed: Feb. 9, 2024

(30) Foreign Application Priority Data
Feb. 10, 2023 (SG) 10202300348V

(51) Int. Cl. G01S 17/931; B60W 30/09; B60W 30/095; B60W 60/00

(52) U.S. Cl. CPC G01S 17/931; B60W 30/09; B60W 30/0953; B60W 60/0015; B60W 2300/14; B60W 2420/408; B60W 2554/20; B60W 2554/4023; B60W 2554/4029

(57) ABSTRACT

Systems, methods, and non-transitory computer program product are described herein for detecting location aspects of an autonomous vehicle to avoid collisions. Data including a plurality of points characterizing a trailer of an autonomous vehicle are received from a first scanning device. A first plane associated with the trailer is defined based on the plurality of points exceeding a first predetermined threshold. It is determined whether the first plane is perpendicular to ground. Based on the first plane being perpendicular to the ground, an orientation of the trailer is determined based on the first plane. Maneuvering of the autonomous vehicle is controlled through one or more commands based on the orientation.

### PRIORITY CLAIM

The present application claims priority to Singapore Application No. 10202300348V, filed Feb. 10, 2023, the contents of which is incorporated by reference herein in its entirety.

### TECHNICAL FIELD

The subject matter described herein relates to detecting trailers of autonomous vehicles.

### BACKGROUND

Automation is the use of computing systems to accomplish various tasks without the need of human intervention. Various industries utilize automation to complete tasks, for example, to reduce costs and/or improve efficiency. Example industries that use such automation include the automotive industry and shipping industry.

### BRIEF DESCRIPTION OF THE DRAWINGS

Aspects of the present disclosure are best understood from the following detailed description when read with the accompanying figures:

FIG. 1 is a block diagram illustrating autonomous vehicles maneuvering within an environment in accordance with various embodiments of the present disclosure.

FIG. 2A is a diagram illustrating a side view of an example autonomous vehicle in accordance with various embodiments of the present disclosure.

FIG. 2B is a diagram illustrating a top view of the example autonomous vehicle in accordance with various embodiments of the present disclosure.

FIG. 3 is a diagram illustrating a side view of an example APM head in accordance with various embodiments of the present disclosure.

FIG. 4 is a diagram 400 illustrating a top view of multiple LiDAR scanning zones that cumulatively form a 360-degree LiDAR scanning zone of an example autonomous vehicle in accordance with various embodiments of the present disclosure.

FIG. 5 is top view of an autonomous vehicle that is turning in accordance with various embodiments of the present disclosure.

FIGS. 6A-6B is a process flow diagram illustrating a method of real-time trailer orientation and position detection in accordance with various embodiments of the present disclosure.

FIG. 7 is a process flow diagram illustrating a method of trailer detection in accordance with various embodiments of the present disclosure.

FIG. 8 illustrates an example trailer detection system that processes input data and generates output data in accordance with various embodiments of the present disclosure.

FIG. 9 is a diagram illustrating a sample computing device architecture for implementing various aspects described herein in which certain components can be omitted depending on the application.

### SUMMARY

In one aspect, a method for detecting location aspects of an autonomous vehicle to avoid collisions includes receiving, from a first scanning device, data comprising a plurality of points characterizing a trailer of an autonomous vehicle. A first plane associated with the trailer is defined based on the plurality of points exceeding a first predetermined threshold. An angle associated with the first plane and a second plane associated with a head of the autonomous vehicle is evaluated. An orientation of the trailer as the first plane based on the angle. Maneuvering of the autonomous vehicle is controlled through one or more commands based on the orientation.

In some variations, the method can also include receiving, from a second scanning device, a plurality of side points characterizing a side of the trailer. A second plane associated with a side of the trailer can be defined based on the plurality of side points exceeding a second predetermined threshold. It can be determined whether the second plane is perpendicular to the ground. The orientation of the trailer is updated to include aspects of the first plane based on the difference being less than a third predetermined threshold when the second plane is perpendicular to the ground.

In other variations, the second predetermined threshold can be at least four times larger than the first predetermined threshold.

In some variations, the second scanning device can be mounted on a right side of a front bumper of the autonomous vehicle or on a left side of the front bumper.

In other variations, at least one of the first plane or the third plane can be determined using a random sample consensus model.

In some variations, at least one of the first scanning device or the second scanning device can be a light and detection ranging (LiDAR) device and the plurality of points or the plurality of side points includes a plurality of LiDAR points.

In other variations, the autonomous vehicle can be an autonomous prime mover and the environment can be a shipping port environment.

In some variations, the first scanning device can be mounted in a perpendicular manner on the autonomous vehicle.

Non-transitory computer program products (i.e., physically embodied computer program products) are also described that store instructions, which when executed by one or more data processors of one or more computing systems, cause at least one data processor to perform operations herein. Similarly, computer systems are also described that may include one or more data processors and memory coupled to one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the examples.

### DETAILED DESCRIPTION

Autonomous vehicles operate with minimal to no human interaction. There are numerous ways autonomous vehicles are utilized in both personal and commercial settings. In a personal setting, for example, people can use autonomous vehicles to get from point A to point B such as driving to or from work or school. In a commercial setting, autonomous vehicles can be used to transport people or goods from point A to point B such as placing goods onto or retrieving goods off of stock shelves in retail spaces or storage warehouses or moving shipping containers around in a shipping port. Shipping ports can have a number of vehicles as well as people maneuvering about. Safety is paramount in a shipping port. The autonomous vehicles described herein are equipped with a trailer detection system that provides real-time observation of the position and/or orientation of a trailer of an autonomous vehicle. Awareness of the position and/or orientation of the trailer can prevent collisions between the autonomous vehicle and its surrounding such as pedestrians, other vehicles or objects maneuvering about the shipping port, and/or stationary vehicles or objects in the shipping port. The precision described herein may not be attainable by humans due to lack of visibility and positional feedback of human eyes.

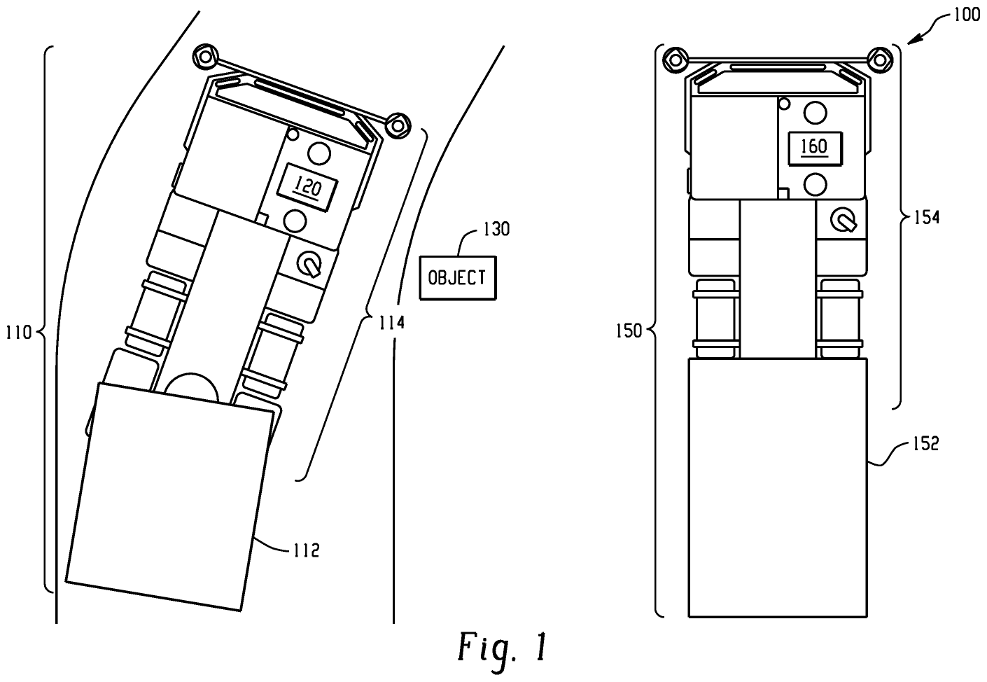

FIG. 1 is a block diagram illustrating autonomous vehicles 110, 150 maneuvering within an environment 100 in accordance with various embodiments of the present disclosure. Autonomous vehicle 110 includes a trailer 112 and a head 114. Similarly, autonomous vehicle 150 includes a trailer 152 and a head 154. When maneuvering about the environment 100, an autonomous vehicle moves either in a straight line or turns. In FIG. 1, autonomous vehicle 110 is turning and autonomous vehicle 150 is moving in a straight line. Avoiding collisions with any objects within the environment 100, such as object 130, is crucial for safety reasons when autonomous vehicles 110, 150 are maneuvering about the environment 100. Object 130 can be another autonomous vehicle, a stationary object such as a shipping container, a pedestrian, or the like. For purposes of illustration, object 130 is shown in the center of environment 100 to the left of autonomous vehicle 150 and to the right of autonomous vehicle 110. However, it can be appreciated that object 130 can be located anywhere within environment 100 (e.g., in front of autonomous vehicles 110, 150, to the side of autonomous vehicles 110, 150, and/or behind autonomous vehicles 110, 150. Using the various algorithms and devices described herein, the autonomous vehicles 110, 150 can each avoid colliding with object 130 using the trailer detection system 120, 160, respectively. The trailer detection system 120, 160 within autonomous vehicle 110, 150, respectively, can detect location features of the trailer 112, 152 such as the position (e.g., where the trailer is located in a plane) and orientation (e.g., where the trailer is pointing in a plane—where it is headed) of its trailer 112, 152 in real-time and can prevent colliding with object 130 by, for example, halting maneuvering of the autonomous vehicle 110, 150 (e.g., via one or more commands that apply a braking mechanism, cease acceleration, turn the autonomous vehicle in another direction, etc.).

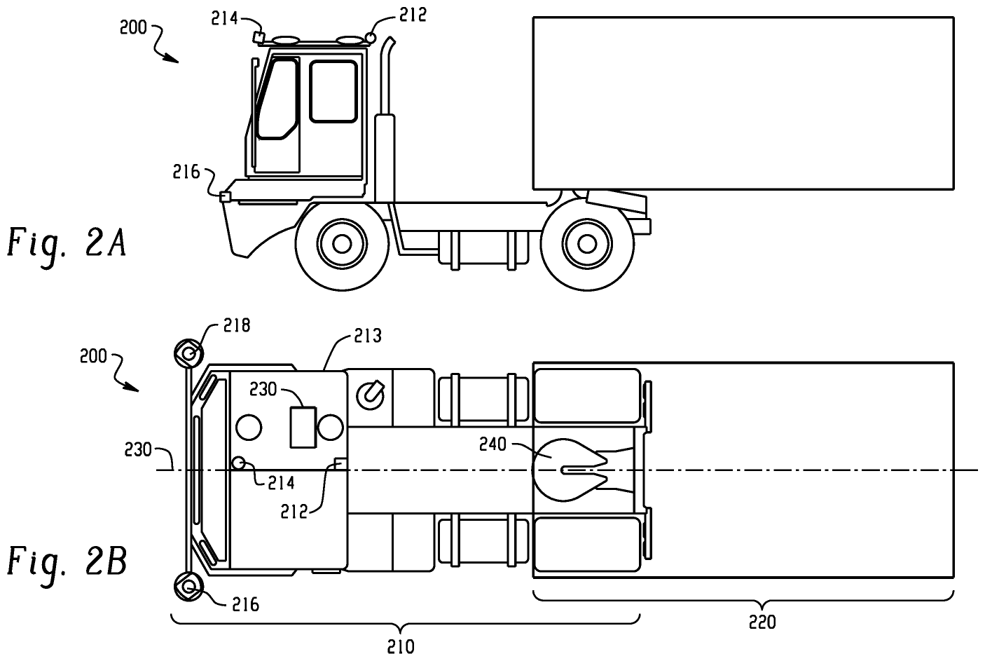

FIG. 2A is a diagram illustrating a side view of an example autonomous vehicle 200 in accordance with various embodiments of the present disclosure. FIG. 2B is a diagram illustrating a top view of the example autonomous vehicle 200 in accordance with various embodiments of the present disclosure. The example autonomous vehicle 200 of FIGS. 2A-2B is specific to the shipping industry. However, it can be appreciated by those of ordinary skill in the art that this is merely an example for illustrative purposes. In an environment 100 that is a shipping port environment such as a container transshipment hub, an example autonomous vehicle 200 is an autonomous platform mover (APM) such as an autonomous prime mover. In this example, the autonomous vehicle 200 includes an APM head 210 and an APM trailer 220. APM trailer 220 can be mounted or secured to the APM head 210 via securing device 240 such as a king pin. For purposes of explanation and ease of understanding, APM trailer 220 is shown in FIG. 2B as transparent to illustrate the mounting device 240. Mounting and/or offloading containers onto the APMs can be performed by an external entity such as crane 210.

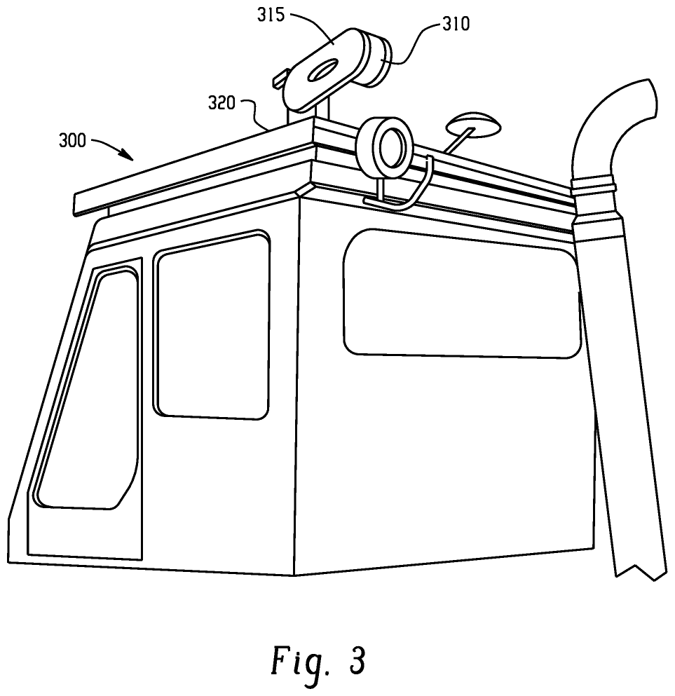

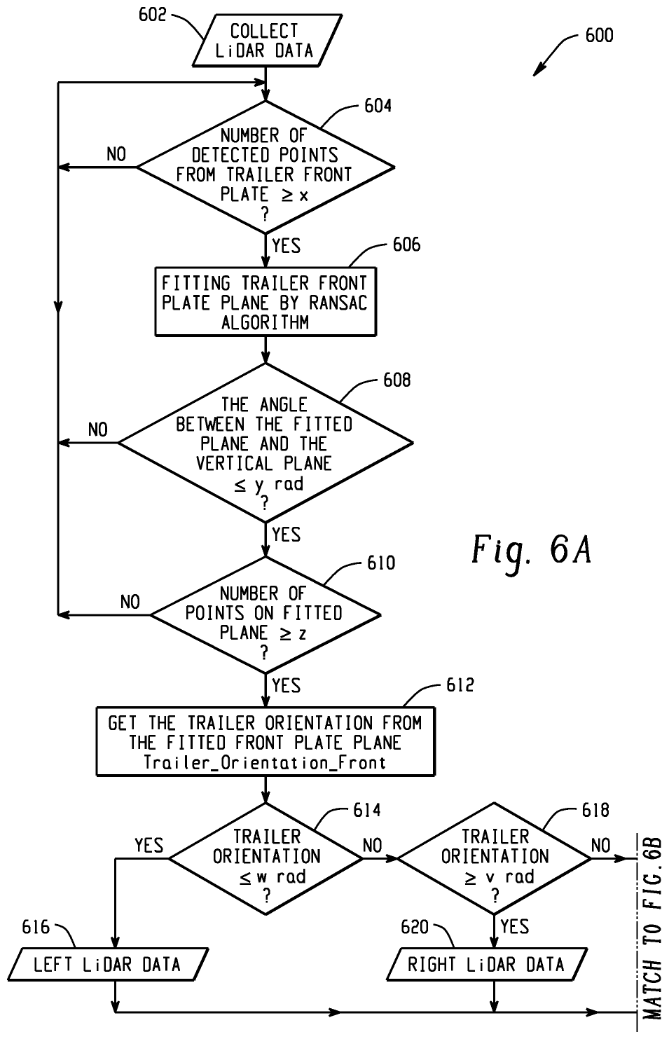

The APM head 210 includes a cabin 213 housing electronics for operation of the autonomous vehicle 200, including the trailer detection system (e.g., trailer detection system 120, 160). The APM head 210 can include one or more LiDAR scanning devices 212, 214, 216, 218 mounted thereon. More specifically, LiDAR scanning devices 212, 214 are mounted on a centerline 230 of the APM head 210 on top of the cabin 213 (e.g., leftmost side edge of the cabin 213). LiDAR scanning device 212 has a view of the area behind the autonomous vehicle 200, to include the trailer 220. LiDAR scanning device 218 has a view of the right side of the autonomous vehicle 200, including a right edge of the trailer 220. LiDAR scanning device 216 has a view of the left side of the autonomous vehicle 200, including a left edge of the trailer 220. The mounting and positioning of the one or more LiDAR scanning devices 212, 214, 216, 218 is described in more detail in FIG. 3. The one or more LiDAR scanning devices 212, 214, 216, 218 can perform scanning to collect data points associated with the trailer 220 to facilitate detecting the position and orientation of trailer 220. At least some, if not all, collected data points from the one or more LiDAR scanning devices 212, 214, 216, 218 (e.g., LiDAR points) are processed by the trailer detection module 120, 160 as described in detail in FIGS. 6A-6B.

Any objects detected behind the APM head 210 can either be the trailer 220 or other objects such as a pedestrian, other autonomous vehicle, stacked container, or the like. Once the orientation of the trailer 220 is determined using the trailer detection system 230 using the LiDAR points as described in detail in FIGS. 6A-6B, the trailer detection system 230 can also determine a position of the trailer 220 based on its known dimensions (e.g., length, width, and height) and rotation point location (e.g., the location of the mounting device 240). With information on the orientation and position of trailer 220, the trailer detection system 230 can define boundaries for the trailer 220. Any detected LiDAR points located inside these boundaries are points detected on the trailer 220 itself. These LiDAR points can be disregarded for the purposes of identifying object 130. Any detected LiDAR points located outside these boundaries are other objects such as obstacles (e.g., other autonomous vehicles, pedestrians, stacked shipping containers, or the like). Autonomous vehicle 200 can utilize information about the detected LiDAR points located outside these boundaries to avoid collisions. For example, the autonomous vehicle 200 can steer around these detected LiDAR points, apply a braking mechanism or cease acceleration of the autonomous vehicle 200 to slow down or stop the autonomous vehicle 200, or the like.

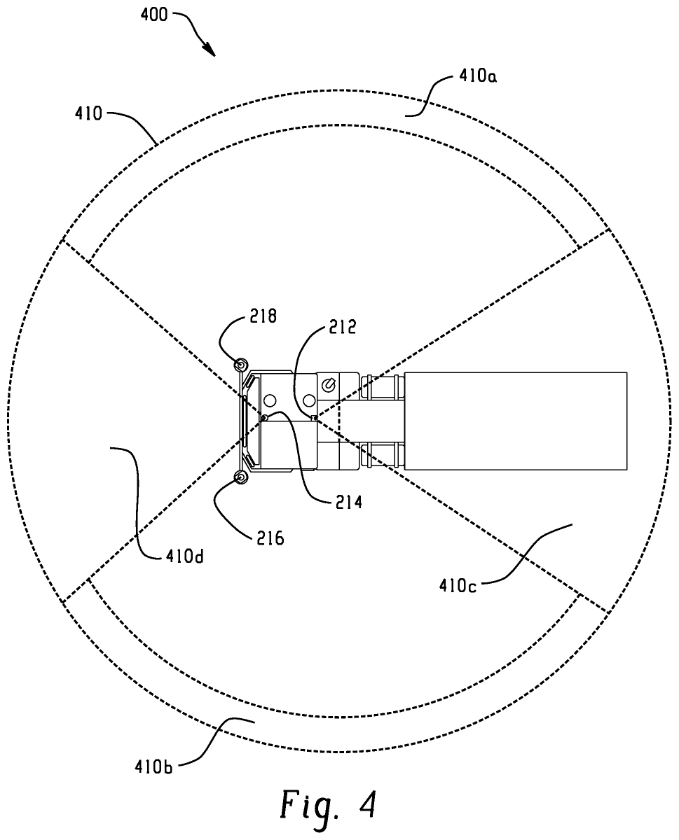

FIG. 3 is a diagram illustrating a side view of an example APM head 300 in accordance with various embodiments of the present disclosure. A LiDAR scanning device 310 (e.g., LiDAR scanning device 212 of FIG. 2A) is mounted on a surface 320 of the APM head 300 (e.g., cabin 213) via a mounting bracket 315. Mounting bracket 315 facilitates the positioning of the LiDAR scanning device 310 approximately perpendicular to the surface 320 of the APM head 300. LiDAR scanning devices 214, 216, 218 are oriented in a horizontal manner (e.g., parallel orientation). The perpendicular orientation of the LiDAR scanning device 310 coupled with multiple LiDAR scanning devices 310 (e.g., equivalent to LiDAR scanning device 212), 214, 216, 218 enables scanning of approximately 360-degrees surrounding the autonomous vehicle 200, to include trailer 220. More specifically, FIG. 4 is a diagram 400 illustrating a top view of multiple LiDAR scanning zones 410a, 410b, 410c, 410d that cumulatively form a 360-degree LiDAR scanning zone 410 of an example autonomous vehicle in accordance with various embodiments of the present disclosure. LiDAR scanning zone 410a is facilitated by the positioning of LiDAR scanning device 218. LiDAR scanning zone 410b is facilitated by the positioning of LiDAR scanning device 216. LiDAR scanning zone 410c is facilitated by LiDAR scanning device 212. LiDAR scanning zone 410d is facilitated by LiDAR scanning device 214. The LiDAR points detected within the 360-degree LiDAR scanning zone 410 can be processed by the trailer detection system 120, 160 as described in detail in FIGS. 6-8.

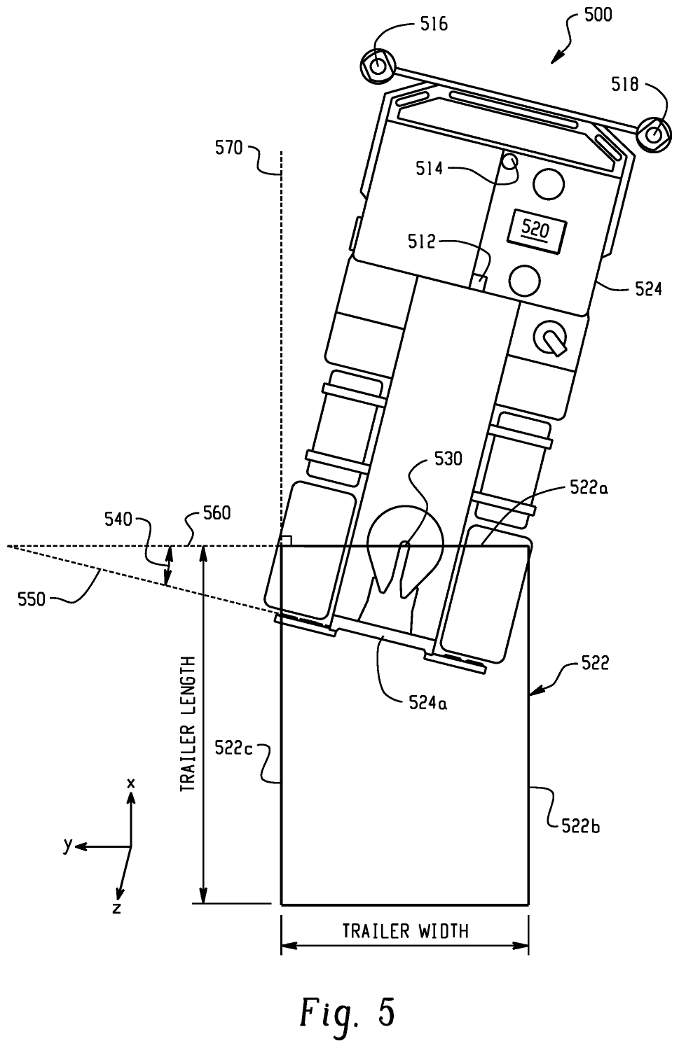

FIG. 5 is top view of an autonomous vehicle 500 that is turning in accordance with various embodiments of the present disclosure. Autonomous vehicle 500 includes a trailer 522 and head 524. Trailer 522 has a front plate 522a and side plates 522b, 522c. Head 524 has a rear plate 524a. When autonomous vehicle 500 is maneuvering in a straight line, a plane 550 defined in the y-direction of the rear plate 524a of head 524 and a plane 560 defined in the y-direction of the front plate 522a of trailer 522 are substantially parallel to each other (e.g., accounting for a distance spacing in the x-direction between the head 524 and the trailer 522) and an angle 540 between the two planes is substantially 0 radians. The presence of an angle 540 (e.g., greater than ˜0.05 radians) between a plane 550 defined in the y-direction of the rear plate 524a of head 524 and a plane 560 defined in the y-direction of the front plate 522a of trailer 522 indicates that the autonomous vehicle 500 is turning. The position and orientation of the trailer 522 can be determined using points detected by LiDAR scanning devices 512, 514, 516, 518 (e.g., equivalent in mounting and functionality to LiDAR scanning devices 212, 214, 216, 218, respectively, of autonomous vehicle 200).

In real-time, LiDAR points detected by at least one of LiDAR scanning devices 512, 514, 516, 518 are provided to trailer detection module 520 for processing. More specifically, LiDAR scanning device 512 has a full view of the trailer 522. When the trailer 522 is turning, as illustrated in FIG. 5, LiDAR scanning device 518 has a view of the right side of trailer 522 and LiDAR scanning device 516 has a view of the left side of trailer 522. When turning, the trailer 522 has a trailer rotation point 530 that is constant. The length, width, and height of the trailer 522 are known parameters for each autonomous vehicle 500. Using the LiDAR points from at least LiDAR scanning devices 512, 516, 518 and the known parameters of the trailer rotation point 530, width of trailer 522, length of trailer 522, and height of trailer 522, the trailer detection module 520 can determine the position (using geometry) and orientation of trailer 522, as described in detail in FIGS. 6A-6B.

FIGS. 6A-6B is a process flow diagram 600 illustrating a method of real-time trailer orientation and position detection in accordance with various embodiments of the present disclosure. The method 600 is performed by the trailer detection system 520. For the purpose of illustration and ease of understanding, FIGS. 6A-6B is described in relation to FIG. 5, however, the method described can utilize any similar features described in FIGS. 1-4. In order to detect the orientation and position of trailer 522, the plane 550 defined in the y-direction of the rear plate 524a of head 524 and the plane 560 defined in the y-direction of the front plate 522a of trailer 522 are first determined using LiDAR data. At step 602, data from one or more LiDAR scanning devices (e.g., LiDAR scanning device 512) is collected and provided to the trailer detection system 520. As previously discussed, LiDAR scanning device 512 has a full view of the trailer 522. At step 604, the number of points detected by LiDAR scanning device 512 is compared against a first threshold (e.g., 100 points). This is to determine whether there are enough collected LiDAR points to define a plane (e.g., plane 560). If the number of points detected by LiDAR scanning device 512 is greater than or equal to the threshold, then a plane 560 of the front plate 522a of trailer 522 is detected and the method moves to step 606. Alternatively, if the number of points detected by the LiDAR scanning device 512 is less than the threshold, the method returns to step 602 and additional LiDAR points are collected.

At step 606, the plane 560 of the front plate 522a of trailer 522 is fitted using a mathematical model such as the random sample consensus (RANSAC) model. RANSAC is an iterative method that evaluates a number of points and estimates a line of best fit amongst the points. That line of best fit defines the plane 560 for the front plate 522a of trailer 522. The plane 550 of the rear plate 524a of head 524 is a known orientation plane. At step 608, an angle between the plane 560 and a plane perpendicular to ground is determined to identify whether the plane 560 (e.g., defined by the front plate 522a of trailer 522) is vertical to ground. The angle is compared to an angle threshold (e.g., approximately 0.05 radians). If the angle is less than or equal to the angle threshold, the method continues to step 610 as the plane 560 is vertical to the ground. If the angle 540 is greater than the angle threshold, then the plane 560 does not accurately represent the front plate 522a of trailer 522 and it should be recalculated by returning to step 604.

At step 610, the number of points detected on the plane 560 are evaluated to determine whether the number is greater than another threshold (e.g., 100 points). This is to determine whether the fitted plane (e.g., plane 560) contains enough LiDAR points. If the number of points detected on the plane 560 is greater than or equal to that threshold, the method continues to step 612. If the number of points is not greater than or equal to the threshold, then the method returns to step 602 as the fitted plane is not reliable and should be discarded.

At step 612, the orientation of trailer 522 is determined based on the plane 560 of the front plate 522a of trailer 522 (e.g., Trailer_Orientation_Front). As previously noted, if the trailer 522 is turning the trailer orientation also takes into account the orientation of the side plates 522b, 522c of trailer 522. To start, however, the orientation utilizes the orientation of the front plate 522a of trailer 522. At step 614, it is determined whether the orientation of the trailer 522 is less than or equal to a first radian threshold (e.g., −0.05 radians). This is to determine whether the trailer 522 is moving in a straight line or turning. More specifically, the angle 540 is converted to radians and then compared to one or more radian thresholds (e.g., −0.05 radians or 0.05 radians). If the orientation of the trailer 522 is less than or equal to the first radian threshold, then the method continues to step 616 as the trailer 522 is turning. When the trailer 522 is turning, the orientation of the sides plates 522b, 522c is evaluated. At step 616, the LiDAR points on the left side of the trailer 522 detected by the LiDAR scanning device 516 are collected. At step 622, the number of detected LiDAR points from the side plate 522c are compared against a threshold (e.g., 400 points). If the number of points is greater than or equal to the threshold, the method continues to step 624. If the number of points is not greater than or equal to the threshold, the method continues to step 626. At step 626, the trailer orientation due to the side plate 522b or side plate 522c (e.g., Trailer_Orientation_Side) is set to zero. Continuing to step 628, the trailer orientation (e.g., Trailer_Orientation) is set to a combination of the front plate 522a of the trailer (e.g., Trailer_Orientation_Front) and the side plate (e.g., side plate 522b or side plate 522c) orientation (e.g., Trailer_Orientation_Side). Under ideal conditions, the orientation of the front plate 522a of trailer 522 (e.g., Trailer_Orientation_Front) is equal to the side plate orientation (e.g., Trailer_Orienation_Side) minus 90-degrees. This is because the trailer 522 is a rectangle and the front plate 522a and the side plate (e.g., side plate 522b or side plate 522c) are perpendicular to each other. The orientation of trailer 522 accounting for both the front plate 522a and the side plate (e.g., side plate 522b or side plate 522c) can be a weighted sum of the two orientations represented by the following expression:

$$trailer\_orientation = 0.5 * ( trailer\_orientation \_front ) + 0.5 * ( trailer\_orientation \_side - 90 degrees ) \qquad ( 1 )$$

Turning back to step 614, if the orientation of the trailer 522 is not less than or equal to the first radian threshold, then the method proceeds to step 618. At step 618, the trailer orientation (e.g., the angle 540 converted to radians) is compared to a second radian threshold (e.g., 0.05 radians). If the trailer orientation is greater than or equal to the second radian threshold, then the method continues to step 620. In other words, if the angle 540 is either less or equal to the first radian threshold (e.g., −0.05 radians) or greater than or equal to the second radian threshold (e.g., 0.05 radians), then the trailer 522 is turning (e.g., not moving in a straight line). At step 620, the LiDAR points on the right side of the trailer 522 detected by the LiDAR scanning device 518 are collected and the method proceeds to step 622.

At step 624, a plane 570 is fit using the RANSAC mathematical model. Although plane 570 is depicted in FIGS. 6A-6B as being associated with the left side plate 522c, it is noted that the plane fit in step 624 depends upon whether the left LiDAR data from LiDAR scanning device 516 is evaluated at step 622 or the right LiDAR data from LiDAR scanning device 518 is evaluated at step 622. If the right LIDAR data is used at step 622, then the plane 570 would be associated with the right side plate 522b on the right side of trailer 522 (not depicted in FIG. 5). At step 630, an angle between the plane 570 and a plane perpendicular to the ground is compared to a radian threshold (e.g., ˜0.05 radians). This is to determine whether the plane 570 is perpendicular to ground. If the angle is less than or equal to the radian threshold, then the method continues to step 632 as it is determined the plane 570 is perpendicular to ground. If the angle is not less than or equal to the radian threshold, then the method continues to step 626 as the plane 570 is not perpendicular to ground and is discarded. At step 632, the number of points collected from LiDAR scanning device 516, 518 are compared to a threshold (e.g., 100 points). If the number of points is greater than or equal to the threshold, then the method continues to step 634. If the number of points is not greater than or equal to the threshold, then the method continues to step 626. At step 632, the trailer orientation is the plane 570 (e.g., Trailer_Orientation_Side). At step 636, a radian difference between the plane 550 and plane 570 is evaluated against a radian difference threshold (e.g., 0.3). If the radian difference is less than or equal to the distance threshold, the method continues to step 628. If the radian difference is not less than or equal to the distance threshold, the method continues to step 626.

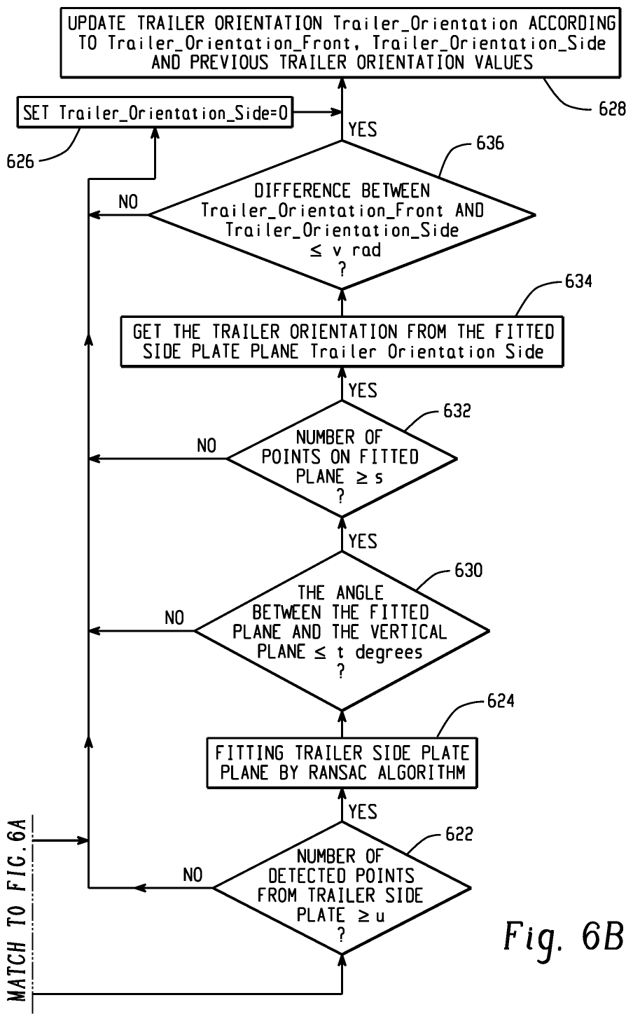

FIG. 7 is a process flow diagram 700 illustrating a method of trailer detection in accordance with various embodiments of the present disclosure. While FIG. 7 is described here with reference to previously described structures, such as FIG. 5, for ease in understanding, it is understood that the method applies to many other structures as well. At step 702, data including a plurality of points characterizing a trailer 522 of an autonomous vehicle 500 are received from a first scanning device (e.g., LiDAR scanning device 512). A first plane (e.g., plane 560) associated with the trailer 522 is defined, at step 704, based on the plurality of points exceeding a first predetermined threshold (e.g., step 604). Determining, at step 706, whether the first plane (e.g., plane 560) is perpendicular to ground. Based on the first plane (e.g., plane 560) being perpendicular to the ground, determining, at step 708, an orientation (e.g., Trailer_Orientation_Front) of the trailer based on the first plane. Controlling maneuvering of the autonomous vehicle 500 through one or more commands based on the orientation to avoid collision with any objects detected near the trailer.

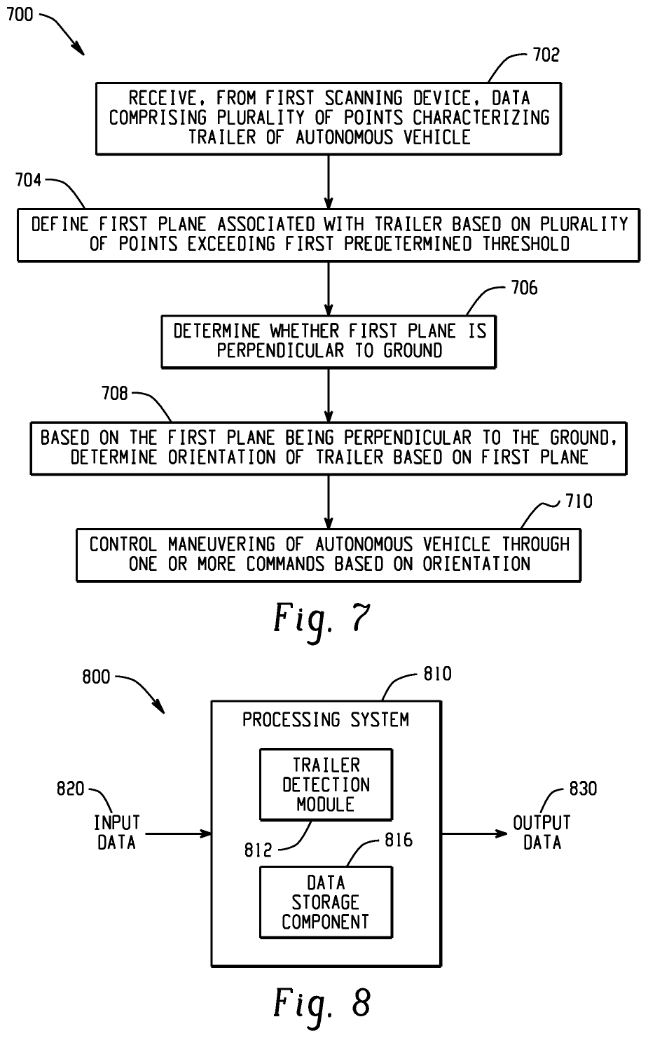

FIG. 8 illustrates an example trailer detection system 800 that processes input data 820 and generates output data 830 in accordance with various embodiments of the present disclosure. The input data 820 can be, for example, the LiDAR data points generated by any of the LiDAR scanning devices 212, 214, 216, 218. The trailer detection system 800 includes one or more processing systems 810. Processing system 810 includes a trailer detection module 812 and a data storage component 816. The input data 820 may be received by the processing system 810 via a communications network, e.g., an Internet, an intranet, an extranet, a local area network (“LAN”), a wide area network (“WAN”), a metropolitan area network (“MAN”), a virtual local area network (“VLAN”), and/or any other network. The input data 820 may also be received via a wireless, a wired, and/or any other type of connection. The input data 820 is processed by the trailer detection module 812 utilizing the algorithms described in detail in FIGS. 6-7.

Processing system 810 may be implemented using software, hardware and/or any combination of both. Processing system 810 may also be implemented in a personal computer, a laptop, a server, a mobile telephone, a smartphone, a tablet, cloud, and/or any other type of device and/or any combination of devices. The trailer detection module 812 may perform execution, compilation, and/or any other functions on the input data 820 as discussed in detail in FIGS. 6-7.

The data storage component 816 may be used for storage of data processed by processing system 810 and may include any type of memory (e.g., a temporary memory, a permanent memory, and/or the like).

Output data 830 can include any data generated by the trailer detection module 812 such as the position and/or orientation of a trailer (e.g., trailer 112, 152, 220, 522) of an autonomous vehicle (e.g., autonomous vehicles 110, 150, 200, 500). Output data 830 can also include an indication to stop or halt acceleration of the autonomous vehicle based on the position and/or orientation of the trailer, any data stored within data storage component 816, or the like.

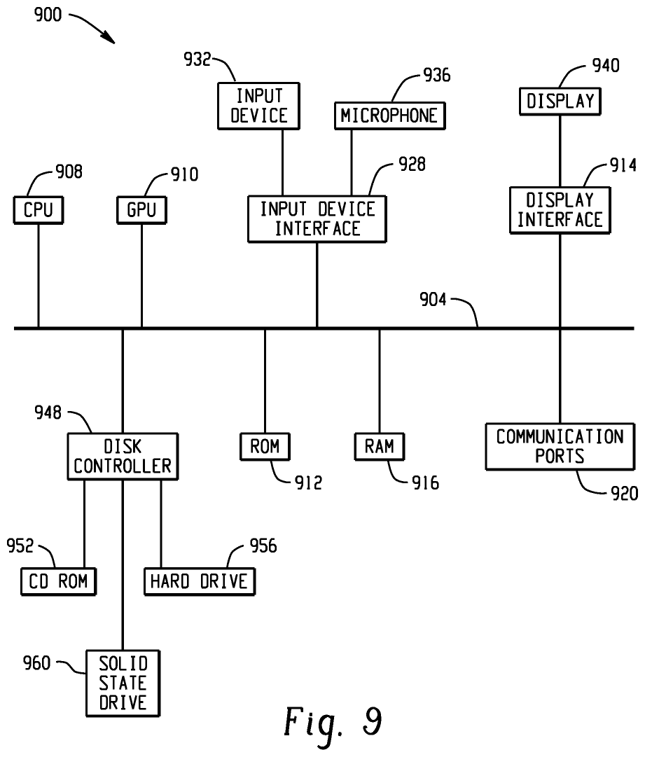

FIG. 9 is a diagram 900 illustrating a sample computing device architecture for implementing various aspects described herein in which certain components can be omitted depending on the application. A bus 904 can serve as the information highway interconnecting the other illustrated components of the hardware. A processing system 908 labeled CPU (central processing unit) (e.g., one or more computer processors/data processors at a given computer or at multiple computers) and/or a GPU-based processing system 910 can perform calculations and logic operations required to execute a program. A non-transitory processor-readable storage medium, such as read only memory (ROM) 912 and random access memory (RAM) 916, can be in communication with the processing system 908 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 948 can interface with one or more optional disk drives to the system bus 904. These disk drives can be external or internal floppy disk drives such as 960, external or internal CD-ROM, CD-R, CD-RW or DVD, or solid state drives such as 952, or external or internal hard drives 956. As indicated previously, these various disk drives 952, 956, 960 and disk controllers are optional devices. The system bus 904 can also include at least one communication port 920 to allow for communication with external devices either physically connected to the computing system or available externally through a wired or wireless network. In some cases, the at least one communication port 920 includes or otherwise comprises a network interface.

To provide for interaction with a user, the subject matter described herein can be implemented on a computing device having a display device 940 (e.g., a CRT (cathode ray tube) or LCD (liquid crystal display) monitor) for displaying information obtained from the bus 904 via a display interface 914 to the user and an input device 932 such as keyboard and/or a pointing device (e.g., a mouse or a trackball) and/or a touchscreen by which the user can provide input to the computer. Other kinds of input devices 932 can be used to provide for interaction with a user as well; for example, feedback provided to the user can be any form of sensory feedback (e.g., visual feedback, auditory feedback by way of a microphone 936, or tactile feedback); and input from the user can be received in any form, including acoustic, speech, or tactile input. The input device 932 and the microphone 936 can be coupled to and convey information via the bus 904 by way of an input device interface 928. Other computing devices, such as dedicated servers, can omit one or more of the display 940 and display interface 914, the input device 932, the microphone 936, and input device interface 928.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

In the descriptions above and in the examples, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the examples is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method for detecting location aspects of an autonomous vehicle to avoid collisions, the method comprising:
receiving, from a first scanning device, data comprising a plurality of points characterizing a trailer of an autonomous vehicle;
defining a first plane associated with the trailer based on the plurality of points exceeding a first predetermined threshold;
determining whether the first plane is perpendicular to ground; based on the first plane being perpendicular to the ground, determining an orientation of the trailer based on the first plane; and
controlling maneuvering of the autonomous vehicle through one or more commands based on the orientation.

2. The method of claim 1, further comprising:
receiving, from a second scanning device, a plurality of side points characterizing a side of the trailer;
defining a second plane associated with a side of the trailer based on the plurality of side points exceeding a second predetermined threshold;
determining whether the second plane is perpendicular to the ground; adjusting, based on the second plane being perpendicular to the ground, the orientation of the trailer to include aspects of the first plane based on the difference being less than a third predetermined threshold.

3. The method of claim 2, wherein the second predetermined threshold is at least four times larger than the first predetermined threshold.

4. The method of claim 2, wherein the second scanning device is mounted on a right side of a front bumper of the autonomous vehicle or on a left side of the front bumper.

5. The method of claim 2, wherein at least one of the first plane or the second plane is determined using a random sample consensus model.

6. The method of claim 2, wherein at least one of the first scanning device or the second scanning device is a light and detection ranging (LiDAR) device and the plurality of points or the plurality of side points comprises a plurality of LiDAR points.

7. The method of claim 1, wherein the autonomous vehicle is an autonomous prime mover and the environment is a shipping port environment.

8. The method of claim 1, wherein the first scanning device is mounted in a perpendicular manner on the autonomous vehicle.

9. A system for detecting location aspects of an autonomous vehicle to avoid collisions, the system comprising:
at least one data processor; and
memory storing instructions, which when executed by at least one data processor, result in operations for implementing operations comprising:
receiving, from a first scanning device, data comprising a plurality of points characterizing a trailer of an autonomous vehicle;
defining a first plane associated with the trailer based on the plurality of points exceeding a first predetermined threshold;
determining whether the first plane is perpendicular to ground;
based on the first plane being perpendicular to the ground, determining an orientation of the trailer based on the first plane; and
controlling maneuvering of the autonomous vehicle through one or more commands based on the orientation.

10. The system of claim 9, further comprising:
receiving, from a second scanning device, a plurality of side points characterizing a side of the trailer;
defining a second plane associated with a side of the trailer based on the plurality of side points exceeding a second predetermined threshold;
determining whether the second plane is perpendicular to the ground; and
adjusting, based on the second plane being perpendicular to the ground, the orientation of the trailer to include aspects of the first plane based on the difference being less than a third predetermined threshold.

11. The system of claim 10, wherein the second predetermined threshold is at least four times larger than the first predetermined threshold.

12. The system of claim 10, wherein the second scanning device is mounted on a right side of a front bumper of the autonomous vehicle or on a left side of the front bumper.

13. The system of claim 10, wherein at least one of the first plane or the third plane is determined using a random sample consensus model.

14. The system of claim 10, wherein at least one of the first scanning device or the second scanning device is a light and detection ranging (LiDAR) device and the plurality of points or the plurality of side points comprises a plurality of LiDAR data points.

15. The system of claim 9, wherein the autonomous vehicle is an autonomous prime mover and the environment is a shipping port environment.

16. The system of claim 9, wherein the first scanning device is mounted in a perpendicular manner on the autonomous vehicle.

17. A non-transitory computer program product for detecting location aspects of an autonomous vehicle to avoid collisions, the non-transitory computer program product storing instructions which, when executed by at least one data processor forming part of at least one computing device, implement operations comprising:
receiving, from a first scanning device, data comprising a plurality of points characterizing a trailer of an autonomous vehicle;
defining a first plane associated with the trailer based on the plurality of points exceeding a first predetermined threshold;
determining whether the first plane is perpendicular to ground;
based on the first plane being perpendicular to the ground, determining an orientation of the trailer based on the first plane; and
controlling maneuvering of the autonomous vehicle through one or more commands based on the orientation.

18. The non-transitory computer program product of claim 17 further comprising:
receiving, from a second scanning device, a plurality of side points characterizing a side of the trailer;
defining a second plane associated with a side of the trailer based on the plurality of side points exceeding a second predetermined threshold;
determining whether the second plane is perpendicular to the ground; and
adjusting, based on the second plane being perpendicular to the ground, the orientation of the trailer to include aspects of the first plane based on the difference being less than a third predetermined threshold.

19. The non-transitory computer program product of claim 18, wherein the second predetermined threshold is at least four times larger than the first predetermined threshold.

20. The non-transitory computer program product of claim 18, wherein the second scanning device is mounted on a right side of a front bumper of the autonomous vehicle or on a left side of the front bumper.

21. The non-transitory computer program product of claim 18, wherein at least one of the first plane or the third plane is determined using a random sample consensus model.

22. The non-transitory computer program product of claim 18, wherein at least one of the first scanning device or the second scanning device is a light and detection ranging (LiDAR) device and the plurality of points or the plurality of side points comprises a plurality of LiDAR data points.

23. The non-transitory computer program product of claim 17, wherein the autonomous vehicle is an autonomous prime mover and the environment is a shipping port environment.

24. The non-transitory computer program product of claim 17, wherein the first scanning device is mounted in a perpendicular manner on the autonomous vehicle.
